(19) United States
(12) Patent Application Publication
(10) Pub. No.: US 2003/0090225 A1
(43) Pub. Date: May 15, 2003

(54) Controller for two DC traction motors

(76) Inventors: Bonne W. Posma, Fort Myers, FL (US); Aleksey Shipillo, Fort Myers, FL (US)

Correspondence Address: Stephen B. Salai, Esq., Harter, Secrest & Emery LLP, 1600 Bausch & Lomb Place, Rochester, NY, 14604-2711, US

(21) Appl. No.: 09/993,852

(22) Filed: Nov. 14, 2001

(51) Int. Cl. H02P 3/14; H02P 3/18

(52) U.S. Cl. 318/376

(57) ABSTRACT

A compact, low loss, transformer-less, reversible dual motor controller for electric vehicles, capable of regenerative braking, and providing good cornering capabilities is described, comprising an AC/DC or DC/DC converter and reversing power switching means to allow either forward or reverse motion. The controller can be modified to allow electric vehicle operation under slippery bottom conditions by the addition of switching means to connect the two DC motors in series across the output of the converter when motoring, and temporarily in “circulating-current-free armature parallel” mode, when one motor spins as a result of slippery bottom conditions.

### FIELD OF THE INVENTION

This invention relates to the control of two DC traction motors connected to a converter powered from an AC or DC source, the system being used to propel an electric vehicle or the like. In such a system, the electric power may be supplied from a remote source via a tether (trailing cable), an overhead trolley wire and power pick up shoe or similar conductor means, or from an onboard diesel electric generator, battery or the like.

### BACKGROUND OF THE INVENTION

It is common practice in both underground and aboveground mining to use remote AC or DC power, or an onboard diesel electric generator to provide electric power to propel vehicles. In many such applications, the AC power is converted onboard to provide controlled current for two DC series motors which provide traction. Where the incoming power is DC, the incoming power is controlled using a DC/DC chopper.

There are a number of different mechanical traction configurations. In one application a rubber-tired shuttle car is powered from a remote AC source via a trailing cable. One DC motor is mechanically coupled to the two wheels on one side, and the other DC motor is mechanically coupled to the two wheels on the other side of the vehicle.

Typical AC voltages supplied to the shuttle car via a trailing cable are 480 Volts 550 Volts and 1000 VAC. DC traction motors are generally rated for 250 Volts DC and 500 Volts DC. It is common practice to transform the incoming voltage onboard to 240 Volts AC and to use two separate AC/DC converters to power the two motors in parallel in a manner that avoids circulating currents between the motors when they operate at different speeds. This is mandated by the requirements that the vehicle's traction system provide good cornering performance and that each motor develop full tractive effort independent of individual motor speed. For example, should one motor spin as a result of slippery bottom conditions, the other motor, on firmer ground, would still be able to develop full torque to allow the vehicle to continue to move. Also, during cornering the vehicle's outside motor will rotate considerably faster than the inside motor, but must still provide appropriate torque without interaction with the slower inside motor.

One common embodiment of an AC/DC converter to power two motors in parallel is the model N10 dual converter manufactured by Saminco Inc. Using SCR's (which as used herein means Silicon Controlled Rectifiers or thyristors) this converter is rated for an input of 240 Volts AC, 3 phase, supplied from a step-down transformer so that the primary current in the supply cable is reduced by a factor equal to the transformer's step-down ratio.

For example, if the AC current supplied to the N10 is 160 Amperes from the 240 Volts AC transformer secondary and the primary voltage is 480 Volts AC, then primary current in the supply cable will be 80 Amperes. During overload conditions, which occur frequently in mining environments, the N10 provides up to 375 Amperes DC per motor for up to 10 seconds (750 Amperes DC total, resulting in 600 Amperes AC from the transformer secondary and 300 Amperes in the primary AC supply). The N10 is rated to supply 100 Amperes DC per motor (200 Amperes DC total) continuously. At 200 Amperes DC, the current drawn by the N10 from the 240 Volt secondary of the transformer would be 160 Amperes AC as mentioned previously.

The N10 and similar competitive parallel dual motor traction controllers provide excellent cornering performance and maintain good traction from all four wheels under slippery bottom conditions.

The entire traction controller system, comprising a transformer and two converters is housed in an explosion proof enclosure if the shuttle car is used in a coal mining or other gaseous mining application. It may be housed in a non-explosion proof housing if used with shuttle cars operating in non-gaseous mines. However, the step-down transformer is expensive, occupies considerable space, and generates heat which is difficult to dissipate in the confines of the controller's housing. Moreover, the parallel converter requirement adds considerably to heat generation.

However, if the transformer were to be eliminated, and the N10 connected directly to the 480 VOLTS AC supply and phased back so that its maximum output voltage were limited to 250 Volts DC, then the AC supply current in the trailing cable would be so high (160 Amperes instead of 80 Amperes) that cable over-heating would result.

The underground terrain for future coal mining operations is becoming more undulating since most of the level coal deposits have been mined out. As a result, a controller providing regenerative braking is becoming very attractive. The same is the case for other “soft rock” operations involved in the mining of such deposits as Potash, Trona and Gypsum.

Lastly, mines must become more productive, and must therefore use larger and faster mining vehicles requiring larger motors requiring higher currents and this will generate even greater heat. Since heat dissipation is limited by the capacity of the surface of the controller enclosure to convey heat to the ambient air, this last requirement will make it very difficult to expand controller capacity to control the larger motors without significantly improving vehicle traction controller methods.

In an attempt to overcome the heating limitations and expense associated with the parallel system, a transformerless converter was developed in 1985, as described in U.S. Pat. No. 4,639,647 issued to Posma. This controller comprises a four quadrant regenerative SCR converter with the two DC traction motors connected in series across its output during motoring and with the motor armatures only in series connected to the SCR converter with separated field excitation during vehicle regenerative braking.

This system worked well in areas with steep grades and good bottom conditions, but suffered from loss of traction in bad bottom conditions if one set of wheels on a slippery section started to spin. Under such a condition, the spinning motor would starve the non-spinning motor connected to the other set of wheels of current, preventing the latter from developing torque to continue vehicle motion.

U.S. Pat. No. 4,633,147 issued to Posma and Hill attempted to address this disadvantage by adding a bypass thyristor across each field, with a fixed voltage differential sensing circuit across each armature, configured to trigger the thyristor across the field of the spinning motor in such a manner as to decrease its ability to develop back EMF, and thus allow the non-spinning motor on firm ground to develop tractive effort.

However, this system was not sufficiently adaptive to operate under all slippery bottom conditions. When one motor spun out, traction would be transferred to the non-spinning motor for a fixed period of time only, while the previously spinning motor was idle, making it difficult to steer the vehicle. Consequently, this invention was not accepted by the industry.

### OBJECTS OF THE INVENTION

It is an object of the present invention to provide a single, transformerless, dual DC traction motor controller for tethered or trolley-fed electric or diesel electric vehicles in which the two DC motors are connected in series across the output of the converter for applications where bottom conditions are always good so as to provide excellent cornering performance and good traction.

It is another object of the invention to provide for a reconfiguration of the aforementioned controller to connect the motors in “circulating-current-free armature parallel” mode during the time one motor spins out as a result of slippery bottom conditions.

It is further object of the invention to provide for a single, transformerless, dual DC traction motor controller generating less heat and occupying less space than a controller system comprising a step-down transformer and two parallel converters.

It is a further object of the invention to provide, in a vehicle supplied with AC via a trailing cable, means for switching the two motors from series to “circulating-current-free, armature parallel” mode when one motor spins out, with both motors retaining full tractive effort capacity but at reduced speed, with the power devices configured to produce a motor current “multiplication effect” with respect to the incoming current, so that AC current in the supply cable would be less compared to the current demanded by the two converter parallel configuration of the above referenced N10 controller, connected to the AC supply without a transformer, so that AC supply cable heating is minimized.

It is a further object of the invention to achieve switching from series mode to “circulating-current-free armature parallel” mode and back to series mode by vehicle driver action. (manual switch-over)

It is a further object of the invention to achieve switching from series mode to “circulating-current-free armature parallel” mode and back to series mode operation automatically.

It is a further object to provide a motor controller occupying less space than existing controllers, and generating substantially less heat compared to existing dual converter systems.

It is a further object to provide very fast voltage limiting for each motor so that a slipping motor armature's voltage rating will not be exceeded during motor “spin out” conditions.

It is a further object to provide a motor slip detection circuit which is automatically adaptive to operating conditions to prevent excessive RPM for the motor on a slippery bottom and to cause corrective action to allow the motor on firm bottom to provide adequate tractive effort to allow the vehicle to continue to move.

It is a further object to provide driver-initiated regenerative braking.

It is a further object to provide all the above features utilizing existing DC series traction motors without the addition of speed sensors, so that the invention can be installed on new electric vehicles as well as a retrofitted to existing electric vehicles.

It is a further object of the invention to provide a controller, able to fit into existing enclosures, but capable of controlling two DC traction motors of greater power ratings than existing motors (at present up to 40 HP for shuttle cars) without generating more heat than the controllers rated for the existing smaller motors.

It is yet another object of the invention to provide a transformerless traction drive powered via a trailing cable from a 1000 Volts AC source using two DC series motors rated for 550 Volts DC connected in series across the output of a single controller according to the invention, configured to operate from 1000 Volts AC.

### BRIEF DESCRIPTION OF THE DRAWINGS

The novel aspects of the invention are set forth with particularity in the appended claims. The invention itself together with further objects and advantages thereof may be more readily comprehended by reference to the following detailed description of a presently preferred embodiment of the invention taken in conjunction with the accompanying drawing in which:

FIG. 1 is a schematic diagram of an embodiment of the invention supplied with AC electric power, comprising a fully controlled SCR phase angle controller with a freewheeling SCR, and a reversible output stage with steering devices connected to two DC series motors. This controller is capable of providing both forward and reverse motoring as well as regenerative braking for both forward and reverse motions for electric vehicles operating on good bottom conditions.

FIG. 2(a) is a graphical representation of the AC line current for the phase angle controller of FIG. 1 during operation at moderate to high speed, and FIG. 2(b) is a graphical representation of the AC line current during low speed operation where current is typically high.

FIG. 3 is a schematic diagram of a presently the preferred embodiment of the invention for a controller powered with AC, incorporating the elements of FIG. 1 and incorporating a fully controlled SCR phase angle controller with a freewheeling SCR and connected to an output stage with extra switching devices to allow operation with good traction for electric vehicles operating on slippery bottom conditions.

FIG. 4 is the schematic diagram of an alternative embodiment of the invention, similar to FIG. 3, but with the input current controller replaced with a three phase rectifier and IGBT buck chopper.

FIG. 5 is a schematic diagram of an input current controller where the input supply is DC instead of AC.

FIG. 6 is a schematic diagram of a combination fully controlled SCR and IGBT chopper input-current controller capable of regenerative braking for both forward and reverse motions, capable of operating with the output stage incorporating motor direction switching devices depicted in FIG. 1 and FIG. 3.

FIG. 7 is a schematic diagram showing the two DC motors in series connected to the current controllers of FIGS. 1, 3, 4 or 5 during motoring or regenerative braking conditions when the vehicle is operating on good bottom conditions.

FIG. 8 is a schematic diagram of the two DC motors when they are temporarily connected to the input controllers of FIGS. 1, 3, 4 or 5 in “circulating-current-free armature parallel” mode when one motor spins as a result of slippery bottom conditions.

FIG. 9 is a schematic diagram of a circuit which is capable of temporarily disconnecting a spinning motor on a slippery bottom from the input controller to permit a motor on firm ground to develop full tractive effort.

FIG. 10 shows in block diagram form a control circuit for the preferred embodiment of FIG. 3.

FIG. 11 shows a block diagram of the function blocks required to control the steering SCR's depicted in FIG. 3 to achieve parallel armature operation in response to manual (operator initiated) or automatic control for operation under slippery bottom conditions.

### DETAILED DESCRIPTION OF THE INVENTION

Embodiment of the Invention with SCR Front End

In order to permit regenerative braking with an SCR primary current controller, the controller is preferably configured as a six SCR fully controlled bridge. However, this type of controller exhibits very poor power factor at a highly retarded trigger angle when an electric vehicle is operating under near stall or heavily loaded low speed conditions.

This condition causes very high current in the AC supply lines, with consequent unacceptable cable heating. To reduce the input AC current, a freewheel diode can be added to the six SCR bridge output to reduce the AC line current under low voltage high current output conditions, but this prevents regenerative braking since the diode would present a short to the motors when their polarities reverse.

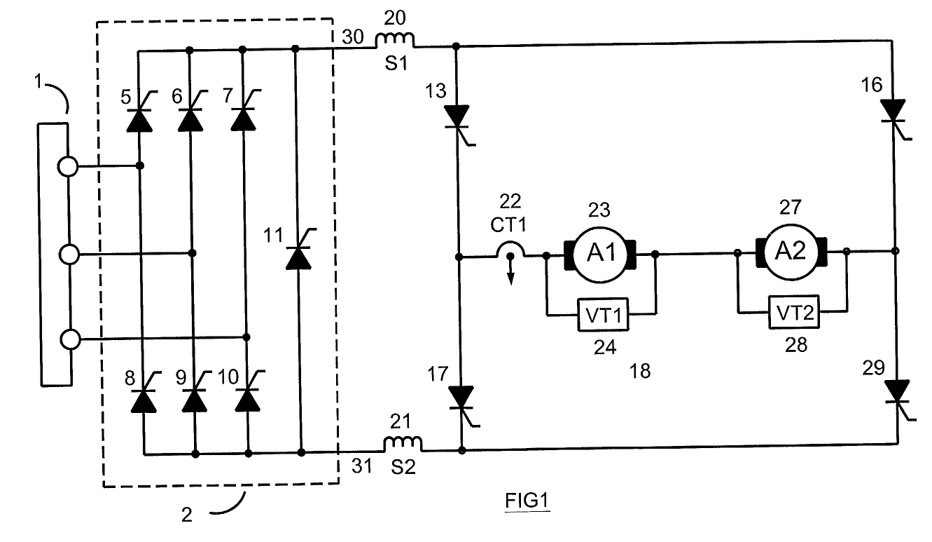

According to the invention, the six SCR bridge is modified by adding a switchable freewheeling diode SCR 11 across its output, as shown in FIG. 1. SCR 11 is switched on during motoring conditions and left off during regenerative braking conditions.

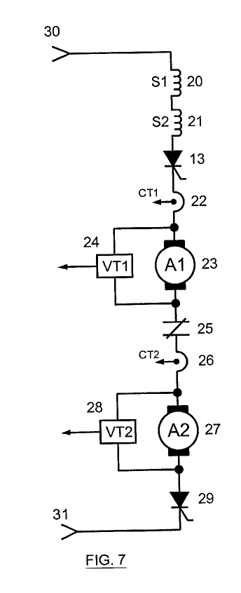

Under normal, good bottom conditions, armatures 23 and 27 of the two traction motors are connected in series as are series fields 20 and 21, as shown in FIG. 1 and FIG. 7.

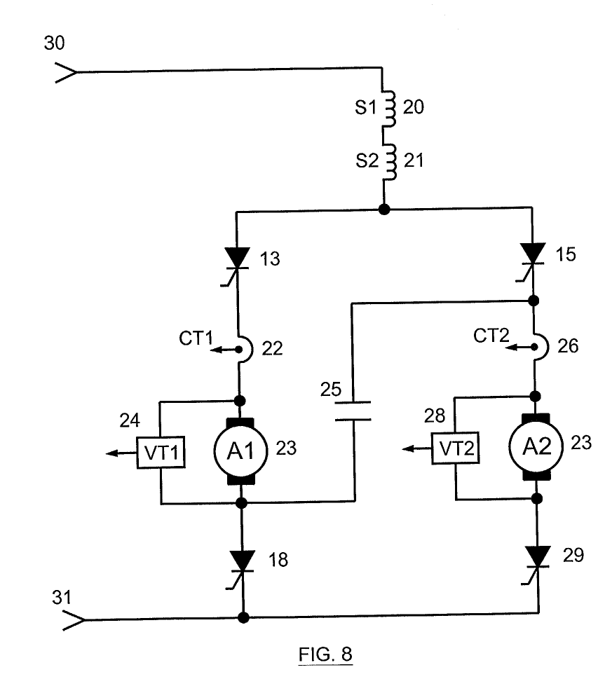

However, if, under bad bottom conditions, one motor were to lose traction and spin out, the armatures would be temporarily connected in parallel as shown in FIG. 8. The fields would remain connected in series, causing double normal field current to flow in each field which would result in the motors developing the same amount of torque for significantly less armature current than would be the case absent the extra field current. To realize the same torque output from each motor, total current from the SCR bridge would still be greater than that with both motors in series, however, it should be recalled that one motor is spinning and drawing very little current, thus total SCR bridge current would not be much greater than occurred when the motor armatures were connected in series.

Therefore, the non-spinning motor, on firm bottom will have a surfeit of torque to allow the vehicle to continue to move, albeit at reduced maximum speed since its field flux has been almost doubled compared to nominal operation. Bearing in mind that the phase angle is highly delayed, freewheeling current in SCR 11 will be substantial, and consequently, AC line current will not be excessive, minimizing cable heating under this temporary parallel armature condition.

Since the spinning motor continues to rotate, it will continue to add to vehicle propulsion and as soon as firm bottom conditions are encountered, it is ready to resume assisting fully to propel the vehicle. Once this occurs, the two motors are switched back to the series connection, as depicted in FIG. 7, which condition minimizes AC current in the cables for full torque output from each motor.

AC line current during the temporary parallel connection may even be less, or at worst, only slightly greater than during full series connection under normal operation, consequently, cable heating will be minimal.

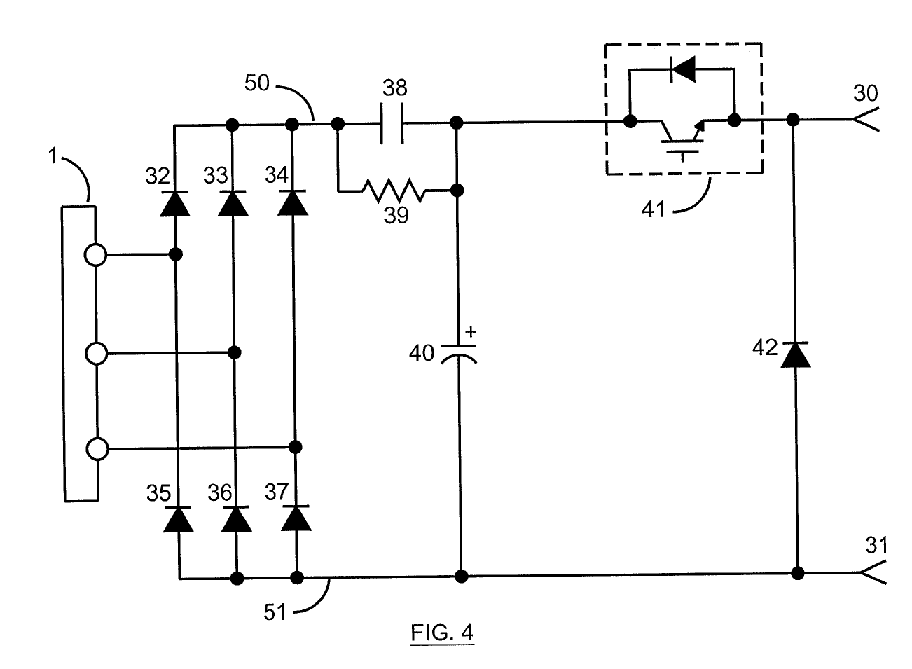

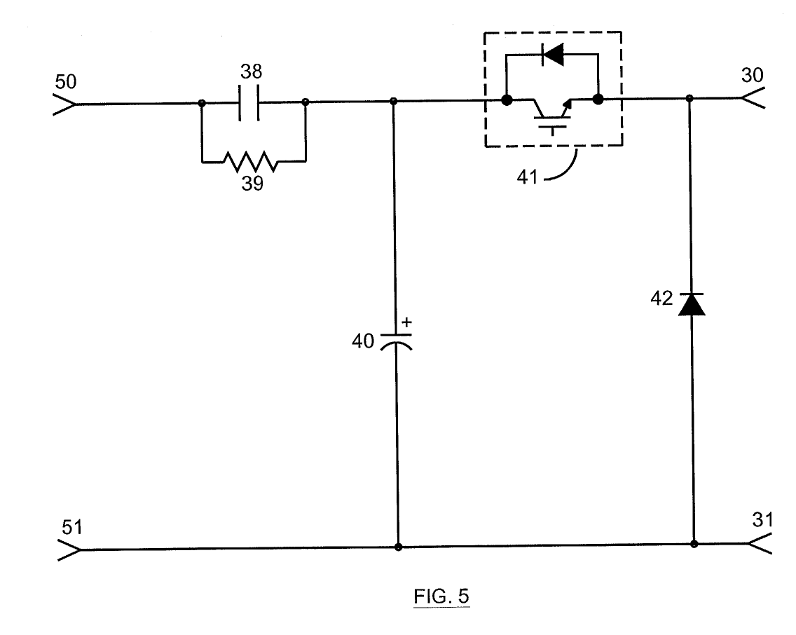

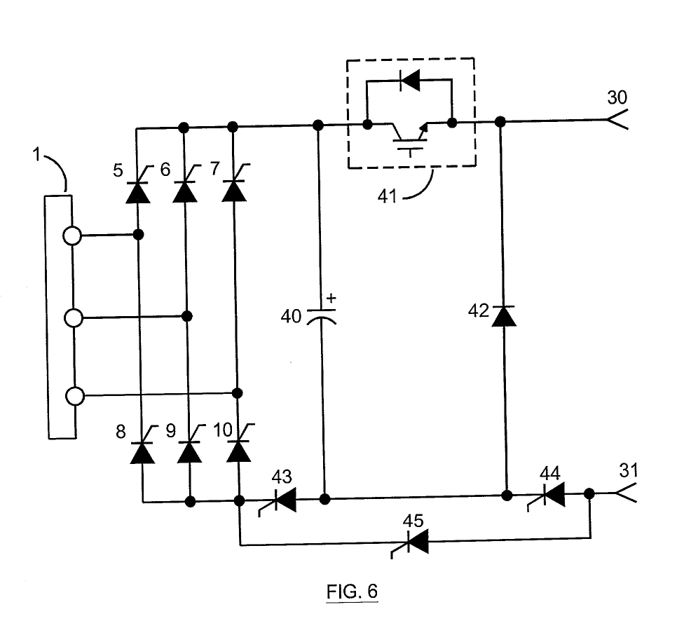

Embodiment of the Invention with DC Supply and Chopper Control

Where the supply current is rectified AC or battery supplied DC, a chopper is used as the main current control element, as depicted in FIG. 4, FIG. 5 and FIG. 6.

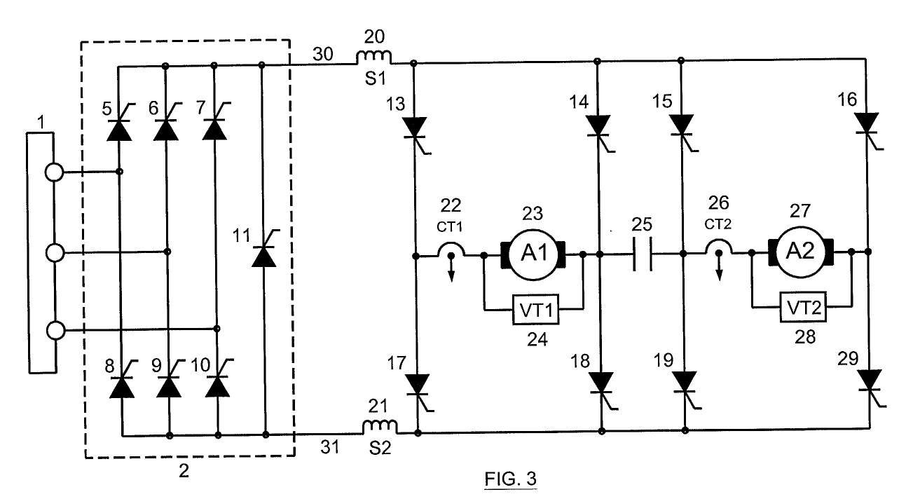

This chopper is connected to the output stage with solid state direction reversing switches (SCR's) and motors connected to lines 30 and 31 as shown previously in FIG. 1 and FIG. 3.

The chopper operates as a pulse width modulated (PWM) current controller with significant current flowing in the freewheeling diode 42 during most of the time the motors are energized. During freewheeling current periods, no current is drawn from the supply lines, and this phenomenon creates a “DC current transformer” where the input current is a fraction of the output current approximately proportional to the PWM duty cycle. For example, if the current in the motors is 1000 Amperes at a PWM duty cycle of 10%, ignoring losses, the average DC line current would only be 100 Amperes, and if the DC was supplied from a three phase rectified AC source, the AC line current would only be 80 Amperes.

FIG. 6 shows a combination SCR input controller and chopper allowing chopper operation with its current transformer properties plus the ability to permit regenerative braking.

The invention is now described in more detail.

FIG. 1 shows an embodiment of the invention where the input power supply is a three-phase AC source 1.

The three phase power is connected to a fully controlled SCR bridge 2, that includes six SCR's 5-10 and has a positive output bus 30 and a negative output bus 31. A freewheeling SCR 11 is connected between busses 30 and 31 with its cathode connected to bus 30 and its anode to bus 31.

A first motor series field 20 is connected to positive output bus 30 and is associated with first motor armature 23. A second motor series field 21 is connected to negative output bus 31 and is associated with second motor armature 27. As an alternative, both series field windings can be connected to the same bus, either positive bus 30 or negative bus 31.

Steering SCR's 13, 16, 17 and 29 control the direction of rotation of the motors. To produce FORWARD motor rotation, SCR 13 and SCR 29 are turned on, and SCR 16 and SCR 17 are turned off. To produce REVERSE motor rotation, SCR 16 and SCR 17 are turned on, and SCR 13 and SCR 29 are turned off. A DC current transducer 22 measures current flow through the two motors and first and second voltage transducers 24 and 28 are connected across armatures 23 and 27 respectively to provide armature voltage feedback.

When the controller is switched to produce either FORWARD or REVERSE rotation, current in the motors is controlled by varying the phase angle in SCR bridge 2 in accordance with the vehicle operator's current demand signal and actual current feedback signal as measured by current transducer 22. If measured current falls below demanded current, the phase angle signal provided to SCR bridge 2 is advanced, and if it exceeds demanded current, the phase angle is retarded. During “motoring” operation, freewheeling SCR 11 is continuously switched ON to provide for a freewheel path for motor current during low conduction and heavy current demand conditions which might typically occur at low speeds and heavy load conditions. This freewheel action reduces current flow in the AC supply cable compared to a bridge which does not incorporate this freewheel SCR feature, and reduces both cable and motor heating. Motor heating is reduced because the freewheel current action reduces the amount of ripple current in the two motors.

Voltage transducers 24 and 28 provide armature voltage feedback signals to limit the maximum voltage that can be applied to any one motor during a variety of operating conditions, such as one motor slipping, or during fast cornering conditions, where one motor might rotate at a higher RPM than the other motor, and might otherwise cause harmful excessive voltage to be applied to the faster motor. The voltage feedback signals provide an over-riding clamping action taking precedence over the current demand signal to protect both motors and controller. For example, if two motors rated for 250 Volts are connected in series across the output of an SCR bridge connected to a 480 VOLTS AC supply, the maximum output of such a bridge could be as high 640 Volts DC. By limiting the total voltage to 500 Volts DC, 250 Volts would be applied across each motor during perfect operating conditions. However, if due to non-ideal operating conditions one motor were to speed up, for example if the wheels connected to it were to slip, its voltage might well tend towards a higher voltage, for example 400 Volts. Under such a condition, the SCR bridge's phase angle would immediately be reduced to limit the maximum voltage applied to this motor to 250 Volts. Since the other, non-slipping motor would rotate at a much slower speed, its voltage would drop, and in a typical non-ideal operating situation, one motor voltage would be at 250 Volts, and the other at 100 Volts, for a total SCR bridge output voltage of 350 Volts. This reduced output voltage condition would persist until operating conditions are returned to normal whence the voltages across the two motors would equalize again.

It is important to note that during such occasional imperfect operating conditions, both motors and controller are protected by virtue of the individual voltage feedback feature.

The voltage feedback devices provide another function, namely to establish whether the drive system is in a “motoring” or “regenerative braking” mode and thereby control the switching ON of freewheel SCR 11, as more fully disclosed in the description for FIG. 1.

Suppose that SCR 13 and SCR 29 are switched ON. As current from the SCR bridge 2 begins to flow through motor fields 20 and 21 voltage will develop across armatures 23 and 27. If the motors were already rotating in a FORWARD direction before these directional SCR's were switched ON, then a positive voltage (from left to right in FIG. 1) would be developed across each armature, indicating that rotation was in the “motoring” mode. Similarly, if the motors were stationary when SCR 13 and 29 were switched ON, a positive voltage would start to be developed as measured by voltage transducers 24 and 28. Under both these conditions, it would be safe for SCR 11 to be switched ON to provide for freewheel current when required and a freewheel SCR enabling circuit, described later, provides the appropriate trigger signal for SCR 11.

However, suppose the motors were rotating in the REVERSE direction when SCR 13 and 29 are switched ON. Under such a condition the armature voltages would be negative, and freewheel SCR 11 would be inhibited from switching ON, to allow the SCR bridge to provide for regenerative braking at a level demanded by the operator's current demand signal. Thus, regenerative braking is operator-initiated and consists of switching the direction switches to the opposite direction of vehicle motion. Regenerative braking current is controlled by the operator's torque demand potentiometer, and persists until the vehicle has slowed down to almost zero speed. At that time, should the operator continue to maintain torque demand, the vehicle will start moving in the direction set by the active direction switch and the drive will revert back to “motoring” mode. At this time, SCR 11 will be turned ON to reduce line current as explained previously.

It is during regenerative braking that voltage transducers 24 and 28 provide their most useful function, indeed, consistent, controlled regenerative braking is generally regarded as being very difficult to achieve with DC series wound motors due to the non-linear characteristic of the series motor under generating conditions. Under high speed conditions, absent armature voltage sensing, the series DC motor's output voltage can rapidly reach such a high level that the SCR bridge is not capable of commutating the generated voltage, whence a condition of “shoot-through” occurs where uncontrolled motor current flows through the bridge and eventually to two SCR pairs in the same leg, for example SCR's 5 and 8 might simultaneously remain ON, effectively placing a short across the two DC motors connected in series. This condition would cause potentially destructive currents to flow in the motors and SCR's that failed to commutate.

But with the voltage transducers of the claimed invention, the SCR bridge is phased back well before dangerous voltage levels are produced, so that regenerative braking still occurs, but at a safe, reduced current level.

When SCR 16 and 17 are switched ON to provide for REVERSE rotation, the action of the transducer is similar to that described for FORWARD rotation, except that the voltages sensed by voltage transducers 24 and 28 are reversed to provide the gating signals for freewheel SCR 11 and to provide over-riding voltage limiting during both motoring and regenerative braking conditions.

The controller shown in FIG. 1, as described above, is suitable for operation where there exist good bottom conditions for an electric vehicle, but suffers from lack of traction due to motor “spin out” when muddy, slippery and uneven bottom conditions are encountered. The embodiment of FIG. 3, described later provides a solution to this problem.

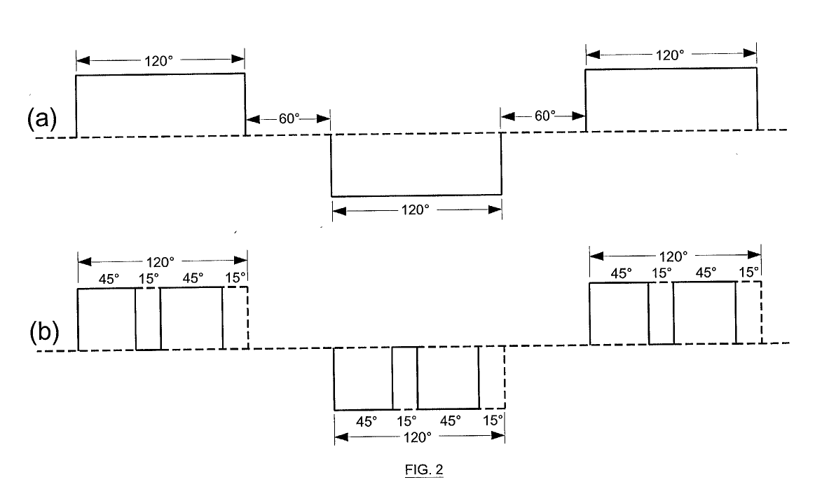

FIG. 2(a) and 2(b) show the beneficial action of freewheel SCR 11 in the controller of FIG. 1 on reducing AC line current.

FIG. 2(a) shows the line current as a result of motor current during so-called “continuous conduction” typically occurring during medium to high speed conditions and medium to light motor loading conditions. The voltage across bus 30 and 31 of FIG. 1 never falls below zero and no freewheeling action can therefore occur during this region of operation. The current in each line consists of 120° rectangular current blocks, separated by 60°.

However, during low speed, heavy loading conditions, and absent the freewheel SCR 11, the voltage across buses 30 and 31 does fall below zero to produce 120° current blocks in each line as described before but a significant amount of current can actually flow from the motors at the end of the phase angle period as a result of the stored energy in the field and armature inductances of the motors. When freewheel SCR 11 is switched ON during motoring conditions it will immediately conduct when the voltage across buses 30 and 31 reverses at the end of the phase angle period, thus preventing the current due to the stored energy from circulating through the AC supply lines.

FIG. 2(b) shows an example of line current flow for typical operating condition at low motor speed. In the example shown, current from the AC supply 1 is drawn for only 45°, followed by a 15° period when freewheel current flows as a result of the action of freewheel SCR 11. Another 45° period follows this, during which line current is absorbed, followed by another 15° of freewheeling action. Consequently, line current is reduced by 25% compared to a situation where a freewheel SCR was not provided.

FIG. 3 shows a presently preferred embodiment of the invention for an AC powered controller provided for an electric vehicle operating under bad, slippery bottom conditions.

This circuit configuration comprises the basic components of FIG. 1 with the addition of a second DC current transducer 26, a normally open contactor 25, and steering SCR's 14, 15, 18 and 19.

During motoring operation, contactor 25 closes and direction is determined by triggering SCR's 13 and 29 for FORWARD rotation and SCR's 16 and 17 for REVERSE rotation, essentially as per the description for FIG. 1. This condition is depicted in simplified form in FIG. 7.

Should a condition be encountered during FORWARD motoring (SCR 13 and 29 ON) when one motor starts to “spin out”, then SCR bridge 2 is immediately shut down and contactor 25 is opened. The two motor armatures are now separate. As soon as contactor 25 opens, SCR 13 and 18 are triggered to allow first motor armature 23 to rotate in the FORWARD direction, and SCR's 15 and 29 are triggered to allow second motor armature 27 to rotate in the FORWARD direction, with both motor armatures now connected in parallel. This condition is depicted in FIG. 8 Shortly thereafter, SCR bridge 2 is phased ON again and subject to armature voltages being of the correct polarity, freewheel SCR 11 is turned ON.

In response to the driver's current demand signal, current will start to flow through both armatures connected in parallel across the output of SCR bridge 2. Current through each motor will be limited to the greater of DC current transducers 22 or 26 output, so that maximum rated motor current cannot be exceeded. Moreover, voltage transducers 24 and 28 provide armature voltage feedback signals to generate an overriding phase angle limit to prevent SCR bridge 2 output from exceeding motor voltage rating.

Up to twice the normal motor current may now flow through each motor field 20 and 21 during the time the two motors are placed in parallel. This will reduce maximum motor speed, but will also provide rated torque per motor for less than rated motor current. Typically, this configuration will provide rated torque for 70% of rated motor current. Hence, each field might see 140% of rated motor current for the short duration that the parallel configuration exists. Moreover, it would be impossible for the spinning motor to rotate at high, potentially destructive RPM, due the presence of a significant field flux in the spinning motor.

Freewheeling SCR 11 is particularly beneficial in this configuration where SCR bridge 2 is in a significant “phase back” operating condition required to satisfy the low output voltage requirement of the two motors in parallel. It will divert a substantial amount of freewheeling current away from the AC supply cables and thereby minimizes cable heating.

The problem of circulating current between the two armatures is avoided because the direction changing SCR's are diodes, preventing reverse current flow. Thus, it would be possible for the two motors to operate at different voltages without the armature with higher voltage feeding into the armature with lower voltage. This feature permits excellent cornering under the parallel armature configuration.

As is clear from the above, this circuit configuration is correctly described previously as “circulating-current-free armature parallel” mode connection.

As soon as the previously spinning motor is on firmer ground, it will start drawing current and will contribute to the propulsion effort. At this point, SCR bridge 2 is momentarily inhibited, all direction-changing SCR's are inhibited and contactor 25 is closed, whereupon SCR's 13 and 29 only are switched ON and SCR bridge 2 is phased ON again to resume motoring in the FORWARD direction.

Switching from “series” to “parallel” and back to “series” can be manual or automatic, as described later.

The above description refers to FORWARD rotation. It will be obvious that a similar result can be obtained for REVERSE rotation, involving steering SCR's 16 and 17 for “series” operation and in the case of “parallel” operation SCR's 14 and 17 for first motor REVERSE rotation, and SCR's 16 and 19 for second motor REVERSE rotation.

FIG. 4 is a schematic diagram of a controller in accordance with the invention with an AC supply input where SCR bridge 2 of FIG. 1 and FIG. 3 has been replaced with a full wave three phase rectifier comprising diodes 32, 33, 34, 35, 36 and 37 with positive output bus 50 and negative output bus 51 connected to energy storage capacitor 40. Resistor 39 and by-pass contactor 38 provide a “soft charge” circuit to allow capacitor 40 to charge to full voltage without the occurrence of a large current surge when AC power is first applied to the rectifier. Power semiconductor 41, which is preferably an IGBT (Insulated Gate Bipolar Transistor) and freewheel diode 42 provide a “buck chopper” to allow current control into the motors connected together with the steering SCR's of FIG. 1 and FIG. 3 to positive bus 30 and negative bus 31. Current feedback for chopper control is by means of DC current transducers 22 and 26 of FIG. 3.

Series and parallel operation are as depicted in FIG. 7 and FIG. 8 respectively.

The advantage of the rectifier/chopper circuit is that it performs a DC/DC transformer-like action in that primary input current is reduced by the ratio of output voltage to input voltage. For example, if the DC bus voltage is 640 Volts and the output voltage is 64 volts, and if 500 Amperes flows through the motors, then the primary DC average current would be approximately 50 Amperes, or only 40 Amperes RMS line current. Thus, this configuration would allow the supply of very large motor currents at low speeds with minimum AC line current and consequent minimal cable heating. The action of the steering SCR's is the same as described previously in connection with the embodiments of the invention shown in FIG. 1 and FIG. 3 and the associated descriptions. However, this configuration cannot provide regenerative braking.

FIG. 5 shows a controller according to the invention powered from a DC power source such as a battery, fuel cell or rectified AC source, connected to input terminals 50 (positive) and 51 (negative). A contactor 38 and a resistor 39 provide a “soft charge” function as described previously, when DC power is first applied. Capacitor 40 is an energy storage capacitor sized to absorb ripple current generated by the PWM chopper and input DC power source. The output of this chopper is connected to the motors in series and parallel as depicted in FIG. 7 and FIG. 8 respectively.

FIG. 6 shows an embodiment of the controller with an SCR front end used in combination with a DC/DC chopper but with the ability to regenerate energy to the AC supply line during braking. The SCR bridge comprises SCR's 5, 6, 7, 8, 9, 10. The output of this control stage is connected to the motors in series and parallel as depicted in FIG. 7 and FIG. 8 respectively.

During motoring operation, the SCR bridge ramps up to full conduction under current limit to charge energy storage capacitor 40 without the need for a resistor/contactor soft charge circuit. The buck chopper comprising IGBT 41 and diode 42 control motor current as described previously and additional SCR's 43 and 44 are turned ON during motoring mode. SCR 45 is inhibited during motoring.

During regenerative braking conditions, SCR's 43 and 44 are inhibited and SCR 45 is turned ON. IGBT 41 is also turned fully ON and it is important that it not be turned OFF while regenerative current flows. Regenerative current flow is now controlled by the SCR bridge, with Dc current transducers 22 and 23 providing current feedback and voltage transducers 24 and 28 providing voltage feedback as explained previously. (Refer to FIG. 3).

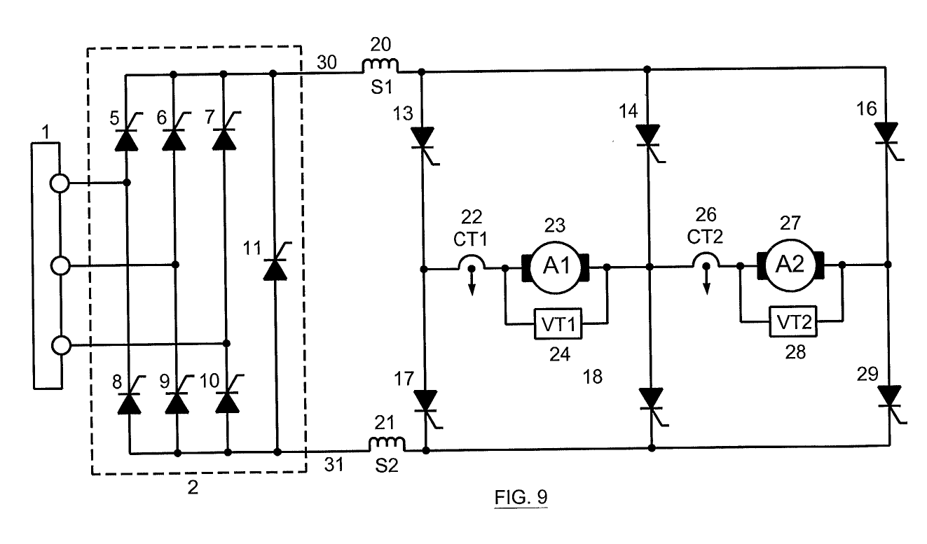

FIG. 9 shows a schematic diagram of an embodiment of the invention in which a spinning motor can be disabled during motoring operation. During FORWARD motor rotation under good bottom conditions, SCR's 13 and 29 are switched ON to provide series operation as depicted in FIG. 7. Should motor armature 23 spin out due to slippery bottom conditions, SCR bridge 2 would be momentarily inhibited. SCR 14 would now be turned ON as well as SCR 29, and SCR 13 would be inhibited. SCR bridge 2 would be phased ON under current limit conditions with DC current transducer 26 providing current feedback. Voltage transducer 28 would provide voltage feedback to limit maximum output voltage to that of the rating of the motor with armature 27, and this motor would provide full torque to propel the vehicle. When good bottom conditions are encountered again, SCR bridge 2 is momentarily inhibited SCR 14 is inhibited and SCR's 13 and 29 are turned ON again to permit continued operation with the two motors connected in series.

Similarly, should the motor with armature 27 spin out, SCR 29 would be inhibited and SCR's 18 and 13 would be turned ON to permit the motor with armature 23 to propel the vehicle until firm ground for both motors is reached, upon which SCR's 13 and 29 would be turned ON and SCR 18 inhibited to restore series operation.

During single motor operation SCR 11 is turned ON to provide a freewheel current path and thereby reduce motor ripple current with consequent minimizing of motor heating. AC supply cable heating is also minimized as explained before.

For REVERSE motor rotation SCR's 16 and 17 are switched ON for series operation, with SCR's 14 and 17 switched ON for single motor reversing operation with armature 23 active, and SCR's 16 and 18 switched ON for single motor reversing operation with armature 27 active.

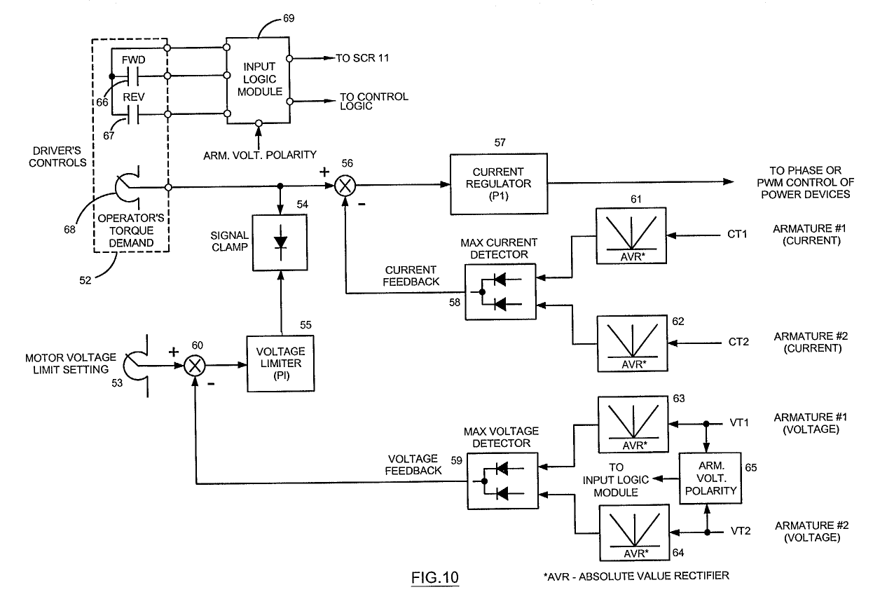

FIG. 10 shows a block diagram of a control circuit of the preferred embodiment depicted in FIG. 3.

The driver's controls are contained within section 52, comprising an operator's torque demand potentiometer 68 and FORWARD and REVERSE direction selection switches 66 and 67 respectively. The operator's torque demand potentiometer may be in the form of an accelerator pedal, hand-controlled joystick, or radio-controlled analog or digital signal. The direction switches may also be separate or be part of the hand-controlled joystick, or may be provided by a radio-controlled digital signal.

The direction selection switches 66 and 67 are connected to input logic module 69 which performs initiating functions and safety checks (not described here, but well known to those designing this type of controller) and establishes whether or not freewheel SCR 11 is to be enabled according to the truth table below. As used herein AVP means Armature Voltage Polarity. AVP module 65 is connected to armature voltage transducers 24 and 28 of FIG. 3 and outputs a logic level HIGH signal when both transducer signals are positive, and a logic level LOW signal when both transducer signals are negative.

| DIR. SWITCH | AVP | SCR 11 | CONDITION |
|---|---|---|---|
| FWD | HIGH | ON | MOTORING |
| REV | LOW | ON | MOTORING |
| FWD | LOW | OFF | BRAKING |
| REV | HIGH | OFF | BRAKING. |

At the same time, if all initiating conditions are satisfied, including a safety check for “Neutral Direction Switch Sensing,” a condition where the controller will only be enabled if both FORWARD and REVERSE direction switches are in the OFF or NEUTRAL position and the operator's torque demand potentiometer is set at ZERO volts prior to the operator applying a torque demand, then and only then will a signal be outputted from module 69 to enable the controller.

Under normal operating conditions the operator's torque demand signal is applied unhampered to the summing junction 56 of PI (Proportional Integral) mode current regulator 57 and compared with current feedback signal 58 to provide the appropriate phase control voltage to the phase shift and trigger circuit for SCR bridge 2 of FIG. 3.

The current feedback signal 58 is the greater of the absolute value of the current signal from DC current transducer 22 associated with armature 23 and the current signal from DC current transducer 26 associated with armature 27. These current transducers are connected to AVR (Absolute Value Rectifier) modules 61 and 62 respectively whose outputs are inputted to Maximum Current Detector module 58, which outputs the greater of these two input signals.

Should conditions occur where one of the motor armatures would be subjected to greater than rated voltage, as set by motor voltage limit setting potentiometer 53, then the voltage limiter PI controller 55 would be enabled to decrease the operator's torque demand signal via signal clamp module 54, to a level where the SCR bridge output would be reduced to the maximum allowable motor armature voltage value.

The voltage limiting circuit obtains an armature voltage feedback signal via voltage transducers 24 and 28 of FIG. 3, which are connected to AVR modules 63 and 64 respectively. The output of each AVR is inputted to Maximum Voltage Detection module 59 and the greatest of these two voltages becomes the armature voltage feedback signal applied to the summing junction 60 of Voltage Limiter PI module 55.

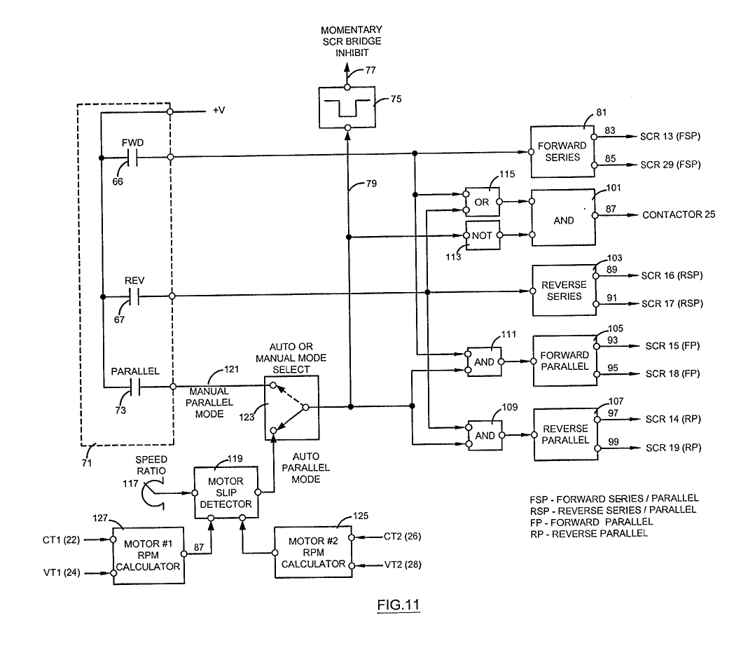

The functions described above can be achieved using analog, digital or microprocessor technologies, which technologies also apply to the functions described in FIG. 11 following.

FIG. 11 is a block diagram of a control circuit in accordance with the invention for controlling the steering SCR's of FIG. 3 for series and parallel mode operation initiated by manual or automatic control.

Under normal operating conditions, when the operator switches either the FORWARD 66 or REVERSE 67 direction switch, OR module 115 will output a HIGH logic level signal to a first input of AND module 101. If the “parallel” mode signal line 79 is at logic LOW, the NOT module 113 will output a logic HIGH signal to the second input of AND module 101 which will output a logic HIGH signal on line 87, causing contactor 25 (refer to FIG. 3) to close, placing the motor armatures effectively in series.

If FORWARD switch 66 is enabled, FORWARD SERIES function block 81 will output trigger signals to FORWARD SCR pairs 13 & 29 via signal lines 83 and 85 respectively and with contactor 25 now closed, FORWARD motoring operation in series can now commence as depicted in FIG. 7.

If REVERSE switch 67 is enabled, REVERSE SERIES function block 103 will output trigger signals to REVERSE SCR pairs 16 & 17 via signal lines 89 and 91 respectively and with contactor 25 closed, REVERSE motoring operation in series can now commence,

The ability to allow the vehicle operator to manually enable “circulating-current-free armature parallel” mode (or simply “parallel” mode) operation requires the addition of a switch 73 labeled “PARALLEL” in new operator control box 71, connected via lead 121 to AUTO/MANUAL MODE SELECT function block 123. This function block is configured to output a logic HIGH signal on line 79 when either switch 73 is closed or when motor slip detection module 119 detects that one motor is spinning. When line 79 goes HIGH, momentary SCR bridge inhibit block 75 outputs a short pulse (adjustable between about 0.1 and 0.5 seconds although it is possible to perform the switch-over function without inhibiting the SCR bridge), via line 77 to reset the SCR bridge to zero output, and ramp up again to a current set by the operator via torque demand potentiometer 68 of FIG. 10.

During the time that the SCR bridge is inhibited contactor 25 of FIG. 3 will open as a result of signal line 87 going to logic LOW because the output of AND gate 101 goes LOW when its second input, the output of NOT inverter 113, goes LOW when its input, “parallel” signal 79 goes HIGH as explained before.

At the same time, SCR pairs 15 & 18 (FORWARD PARALLEL) or SCR pairs 14 & 19 (REVERSE PARALLEL) are enabled, depending on whether the FORWARD or REVERSE direction switch had been activated by the vehicle's driver. Also depending on the state of these direction switches, SCR pairs 13 & 29 (FORWARD) or SCR pairs 16 & 17 (REVERSE) will be enabled to provide the required armature connections in parallel.

Automatic spin out or “slip” detection module 119 is provided with signals equivalent to the RPM of each motor. First motor RPM is calculated in RPM calculator 127 from first motor DC current transducer input 22 and first armature voltage transducer input 24. Second motor RPM is calculated in RPM calculator 125 from second DC current transducer input 26 and second armature voltage transducer input 28. In general, the RPM of a DC series motor can be approximately calculated by using the formula:

RPM=[Vₐ−Iₐ·Rₐ]/K·I_{f}

Where:

K is a motor constant

Vₐ is armature voltage (as measured by a voltage transducer)

Iₐ is armature current (as measured by a DC current transducer)

I_{f} is field current (the same as the aforesaid armature current when the motors are in series mode)

It should be noted that the RPM calculation function is disabled during parallel operation because the field current is not the same as armature current. Moreover, it may be desirable to provide the RPM calculator with actual motor field saturation data to modify the RPM calculation to compensate for field flux saturation effects.

The outputs of the two RPM calculator modules are inputted to motor slip detection module 119 where the ratio of the two speeds is continuously computed. This ratio is compared to a ratio set by speed ratio potentiometer 117 typically set to a ratio between 2 to 5, and if this set ratio is reached, a motor spin out condition will be deemed to exist causing function block 119 to output a logic HIGH signal to initiate switch over to parallel operation.

During parallel operation, the two motor currents are compared. Should they approach equivalence, typically within 30% of each other, it will be deemed that tractive effort will now exist at both motors, and the output of motor slip detector module 119 will now go to logic LOW momentarily inhibiting the SCR bridge as before via inhibit module 75, enabling contactor 25 to place the motors back in series, inhibiting parallel SCR's 14, 15, 18 & 19, and enabling either FORWARD SCR pairs 13 & 29 or REVERSE SCR pairs 16 & 17 depending on the state of direction switches 66 or 67.

While the invention has been described in connection with a presently preferred embodiment thereof, those skilled in the art will appreciate that many modifications and changes may be made therein without departing from the true spirit and scope of the invention which accordingly is intended to be limited solely by the appended claims.

1. A regenerative braking power supply for a direct current traction motor comprising:
a converter including a plurality of controlled solid state switches having an input for receiving power from a power source and an output for providing controlled DC power for a traction motor;
a controllable freewheeling diode connected to the output of the converter; and
a braking controller for disabling the freewheeling diode for regenerative braking of the traction motor.

2. The regenerative braking power supply of claim 1 in which the power source is an AC power source, and the converter comprises a bridge rectifier.

3. The regenerative braking power supply of claim 1 in which the controllable freewheeling diode comprises an SCR having a gate connected to the braking controller.

4. The regenerative braking power supply of claim 2 in which the bridge rectifier comprises a three phase rectifier.

5. The regenerative braking power supply of claim 2 in which the controlled solid state switches comprise SCR's.

6. The regenerative braking power supply of claim 5 comprising a power controller connected to the controlled solid state switches.

7. The regenerative braking power supply of claim 1 in which disabling the freewheeling diode comprises placing the freewheeling diode in a non-conductive state.

8. The regenerative braking power supply of claim 3 in which disabling the freewheeling diode comprises turning the solid state switch off.

9. The regenerative braking power supply of claim 1 in which the power source is a DC power source and the converter comprises a DC/DC converter

10. The regenerative braking power supply of claim 9 comprising a power controller connected to the DC/DC converter.

11. The regenerative braking power supply of claim 9 in which the DC/DC converter comprises a controllable semiconductor switch connected in series with a DC power source, and a chopper controller connected to the controllable semiconductor switch.

12. The regenerative braking power supply of claim 11 in which the chopper controller and controllable semiconductor switch comprise a pulse width modulator.

13. The regenerative braking power supply of claim 11 in which the controllable semiconductor switch comprises an insulated gate bipolar transistor and the chopper controller is connected to a gate terminal of the transistor.

14. The regenerative braking power supply of claim 2 comprising a controllable semiconductor switch connected in series with the bridge rectifier, and a chopper controller connected to the controllable semiconductor switch.

15. The regenerative braking power supply of claim 14 in which the chopper controller and controllable semiconductor switch comprise a pulse width modulator.

16. The regenerative braking power supply of claim 15 in which the controllable semiconductor switch comprises an insulated gate bipolar transistor and the chopper controller is connected to a gate terminal of the transistor.

17. A transformerless dual DC traction motor controller comprising: a solid state power converter having an output;
a mode switcher for connecting two DC traction motors to the output in series in a first mode and connecting two DC traction motors to the output in circulating-current-free armature parallel configuration in a second mode.

18. The transformerless dual DC traction motor controller of claim 17 comprising a driver operable control connected to the mode switcher.

19. The transformerless dual DC traction motor controller of claim 17 comprising a slip sensor responsive to slippery conditions connected to the mode switcher.

20. The transformerless dual DC traction motor controller of claim 19 in which the slip sensor comprises a motor slip detector.

21. The transformerless dual DC traction motor controller of claim 17 in which the solid state power converter comprises an SCR phase angle controller.

22. The transformerless dual DC traction motor controller of claim 17 in which the solid state power converter comprises a DC/DC converter.

23. The transformerless dual DC traction motor controller of claim 17 comprising a freewheeling diode connected to the solid state power converter and in which the mode switcher comprises a solid state switcher reversibly connecting the armatures and the field windings of the DC traction motors in series to the output of the solid state power converter in the first mode, and connecting the field windings of the DC traction motors in series and the armatures of the DC traction motors in circulating current free parallel with each other, and in series with the field windings of the DC traction motors in the second mode.

24. The transformerless dual DC traction motor controller of claim 17 comprising a controllable freewheeling diode connected to the output of the solid state power converter; and
a braking controller for disabling the freewheeling diode for regenerative braking of the traction motor.

25. The transformerless dual DC traction motor controller of claim 24 in which the controllable freewheeling diode comprises a solid state switch comprising a gate connected to the braking controller.

26. The transformerless dual DC traction motor controller of claim 24 in which disabling the freewheeling diode comprises placing the freewheeling diode in a non-conductive state.

27. The transformerless dual DC traction motor controller of claim 26 in which the freewheeling diode comprises an SCR and disabling the freewheeling diode comprises turning the SCR off.

28. The transformerless dual DC traction motor controller of claim 23 comprising a switch connected between the armatures of the DC traction motors, the switch being closed in the first mode, and open in the second mode.

29. The transformerless dual DC traction motor controller of claim 23 in which the solid state switcher comprises a first plurality of controlled solid state switches connected to the first armature, and a second plurality of solid state switches connected to the second armature.

30. The transformerless dual DC traction motor controller of claim 17 comprising a current transducer connected to the DC traction motors to measure the current follow through the motors.

31. The transformerless dual DC traction motor controller of claim 17 comprising first and second voltage transducers connected to the DC traction motors for measuring the voltage applied to the motors.

32. The transformerless dual DC traction motor controller of claim 31 in which the voltage transducers are connected to armature windings of the DC traction motors.

33. The transformerless dual DC traction motor controller of claim 17 comprising an operator current controller; and
a control circuit responsive to the operator current controller and the current transducers connected to the solid state power converter for increasing the power of the power converter if the current sensed by the transducer falls below the current set by the operator current controller, and reducing the power from the power converter if the current sensed by the current transducer is greater than the current set by the operator current controller.

34. The transformerless dual DC traction motor controller of claim 29, in which the first plurality of controlled solid state switches comprises four solid state switches, and the second plurality of solid state switches comprises of four solid state switches.

35. The transformerless dual DC traction motor controller of claim 34 comprising a switch connected between the armature of the first DC traction motor in the armature of the second DC traction motor.

36. A method of controlling two DC traction motors each motor having an armature and a field winding including connecting the field windings of the two DC traction motors in series, connecting the armatures of the DC traction motors to the series connected field windings, and switching the armatures between a first series connected mode and a second circulating-current-free parallel mode.

37. The method of claim 36 comprising switching to the second mode in response to slippery conditions.

38. The method of claim 37 comprising manually switching to the second mode.

39. The method of claim 37 comprising automatically switching to the second mode in response to detecting slippery conditions.

40. The method of clam 39 comprising switching to the first mode in response to the absence of slippery conditions.

41. The method of claim 39 in which detecting slippery conditions comprises sensing motor slippage.

42. The method of claim 36 comprising regeneratively braking the DC traction motors.

43. The method of claim 36 comprising selectively regeneratively braking the DC traction motors.
